(19) United States
(12) Patent Application Publication
(10) Pub. No.: US 2026/0100318 A1
(43) Pub. Date: Apr. 9, 2026

(54) ELECTROMAGNETIC RELAY

(71) Applicants: DENSO CORPORATION, Kariya-city (JP); DENSO ELECTRONICS CORPORATION, Anjo-city (JP)

(72) Inventors: Kentaro YAMAGUCHI, Kariya-city (JP); Shingo KURITA, Kariya-city (JP); Kei ITAKURA, Anjo-city (JP)

(73) Assignees: DENSO CORPORATION, Kariya-city (JP); DENSO ELECTRONICS CORPORATION, Anjo-city (JP)

(21) Appl. No.: 19/416,257

(22) Filed: Dec. 11, 2025

Related U.S. Application Data
(63) Continuation of application No. PCT/JP2024/019563, filed on May 28, 2024.

(30) Foreign Application Priority Data
Jun. 16, 2023 (JP) 2023-099573

(51) Int. Cl. H01H 9/44; H01H 50/12

(52) U.S. Cl. CPC H01H 9/443; H01H 50/12

(57) ABSTRACT

An electromagnetic relay includes a pair of fixed contact terminals arranged; a movable contact terminal that approaches the pair of fixed contact terminals and separates therefrom, thereby making a portion between the pair of fixed contact terminals conducted or cutoff; a contact part between the pair of fixed contact terminals and the movable contact; a contact terminal housing that accommodates the pair of fixed contact terminals, the movable contact terminal and the contact part, the contact terminal housing including an arc extinguishing chamber; and a magnet that produces magnetic field causing the arc to be extended and guiding the arc to the arc extinguishing chamber. In the contact terminal housing, a communication hole is provided, being formed at a portion positioned in a predetermined direction relative to the contact part, the communication hole causing the arc extinguishing chamber to communicate with outside the arc extinguishing chamber.

### CROSS-REFERENCE OF RELATED APPLICATIONS

This application is the U.S. bypass application of International Application No. PCT/JP2024/019563 filed on May 28, 2024, which designated the U.S. and claims priority to Japanese Patent Application No. 2023-099573 filed on June 16, 2023, and the contents of both of these are incorporated herein by reference.

### BACKGROUND

### Technical Field

The present disclosure relates to an electromagnetic relay.

### Description of the Related Art

According to an known electromagnetic relay, a movable member of which the both ends connects and separates to/from a first fixing member and a second fixing member is provided, and an arc extinguishing chamber is provided in a contact housing, being formed in a lateral side of a pair of first and second contacts each formed at each contact part between the first fixing member and the second fixing member, and the movable member. An arc produced at the pair of contacts is lead to the arc extinguishing chamber by a magnetic field of the magnets

### SUMMARY

A first means of the present disclosure is an electromagnetic relay provided with a pair of fixed contact terminals arranged at predetermined intervals; a movable contact terminal that approaches the pair of fixed contact terminals and separates from the pair of fixed contact terminals, thereby making a portion between the pair of fixed contact terminals conducted or cutoff; a contact part between the pair of fixed contact terminals and the movable contact; a contact terminal housing that accommodates the pair of fixed contact terminals, the movable contact terminal and the contact part, the contact terminal housing including an arc extinguishing chamber arc extinguishing chamber formed therein as a space used for extending an arc produced between the fixed contact terminals and the movable contact terminal; and a magnet that produces a magnetic field causing the arc to be extended in a predetermined direction and guiding the arc to the arc extinguishing chamber, wherein a communication hole is provided in the contact terminal housing, formed at a portion positioned in a predetermined direction relative to the contact part, the communication hole causing the arc extinguishing chamber to communicate with outside of the arc extinguishing chamber .

### BRIEF DESCRIPTION OF THE DRAWINGS

The above-described objects and other objects, features and advantages of the present disclosure will be clarified further by the following detailed description with reference to the accompanying drawings. The drawings are:

FIG. 1 is a diagram showing a longitudinal cross-sectional view of an electromagnetic relay;

FIG. 2 is a diagram showing a perspective view of an electromagnetic relay in a state where a casing is removed;

FIG. 3 is a diagram showing a plan view indicating an electromagnetic relay in a state where the casing and an accommodation member are removed;

FIG. 4 is a diagram showing a cross-sectional view of the diagram shown in FIG. 3, sectioned along the IV-IV line;

FIG. 5 is a diagram showing a rear-view of an electromagnetic relay;

FIG. 6 is a diagram showing a longitudinal cross-sectional view indicating a state where an arc is extended;

FIG. 7 is a diagram showing a plan view illustrating a modification example of a fixing member and a communication hole

FIG. 8 is a diagram showing a plan view illustrating a modification example of the communication hole;

FIG. 9 is a diagram showing a plan view illustrating another modification example of a communication hole;

FIG. 10 is a diagram showing a plan view illustrating another modification example of a communication hole;

FIG. 11 is a diagram showing a cross-sectional view of the diagram shown in FIG. 10, sectioned along the XI-XI line;

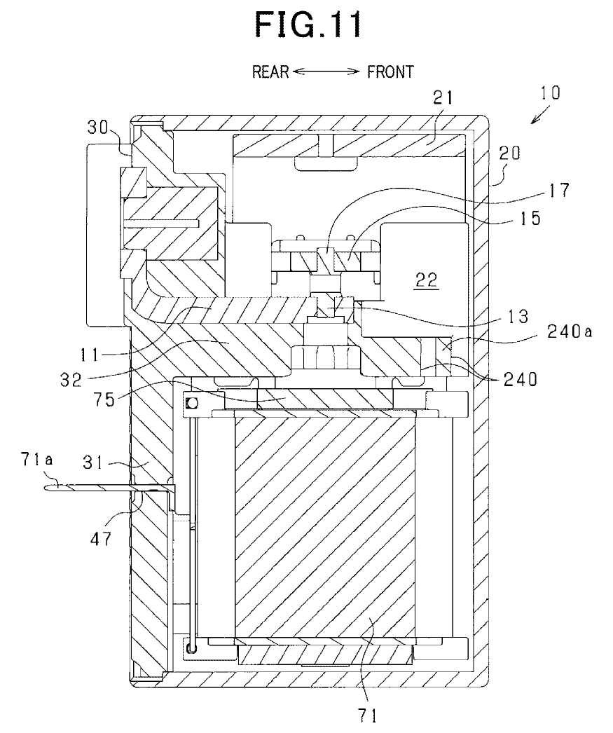

FIG. 12 is a diagram showing a longitudinal plan view illustrating other modification example of a communication hole; and

FIG. 13 a diagram showing a longitudinal plan view illustrating other modification example of a communication hole.

### DETAILED DESCRIPTION OF THE PREFERRED EMBODIMENTS

For example, JP-A-2010-73352 discloses an electromagnetic relay in which a movable member of which the both ends connects and separates to/from a first fixing member and a second fixing member is provided, and an arc extinguishing chamber is provided in a contact housing, being formed in a lateral side of a pair of first and second contacts each formed at each contact part between the first fixing member and the second fixing member, and the movable member. An arc produced at the pair of contacts is lead to the arc extinguishing chamber by a magnetic field of the magnets

In recent years, in an electric vehicle or the like, since a large amount of current flows through an electromagnetic relay, an arc is difficult to cutoff at the electromagnetic relay. Hence, in the electromagnetic relay, the performance of cutting off the arcing is required to be improved.

Hereinafter, with reference to the drawings, an embodiment of an electromagnetic relay connected between a power source and an inverter disposed of a hybrid vehicle or an electric vehicle will be described.

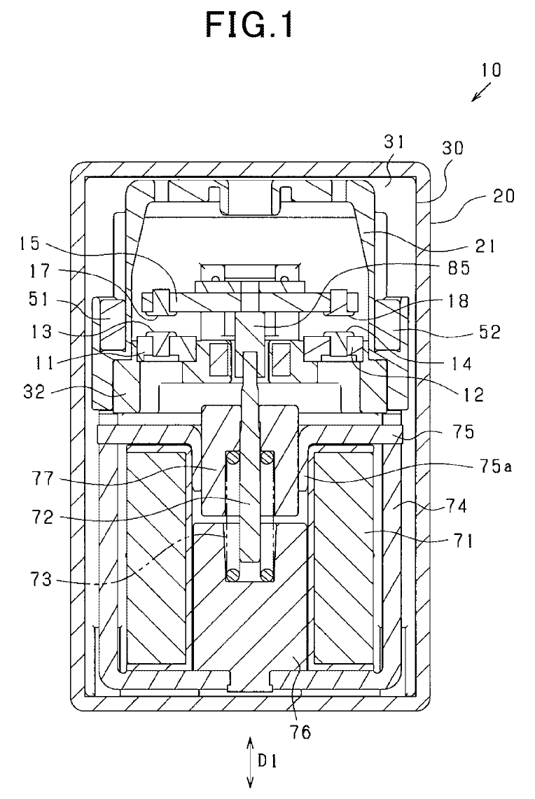

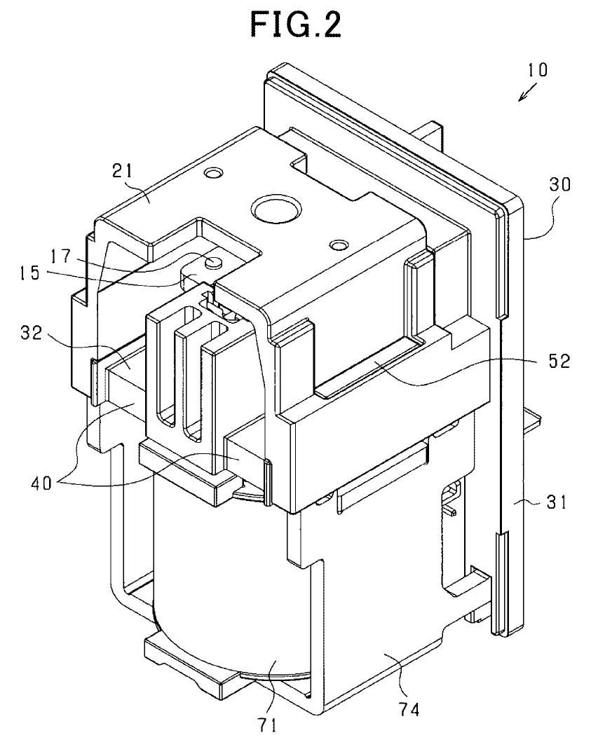

As shown in FIGS. 1 and 2, the electromagnetic relay 10 is provided with a base 30, a magnetic yoke 74, a plate 75, an auxiliary yoke 76, an electromagnetic coil 71, a shaft 72, a spring 73, a movable core 77, an accommodation member 21, a movable contact terminal 15, fixed contact terminals 11, 12, an insulation member 85, a first magnet 51, a second magnet 52, a casing 20 and the like.

The base 30 is formed of an insulation member and is provided with a rear plate member 31, a partitioning member 32 and the like. The rear plate member 31 is formed in a rectangular plate shape. The partitioning member 32 extends from an intermediate portion of the rear plate member 21 in a vertical direction (i.e. longitudinal direction) thereof towards a front part (in a direction perpendicular to the rear plate member 31).

In a part positioned lower than the partitioning member 32 of the base 30, the magnetic yoke 74, the plate 75, the electromagnetic coil 71, the spring 73, the auxiliary yoke 76, the movable core 77 and the like are disposed.

The magnetic yoke 74 is formed in a groove shape (U-shape in a side view). The plate 75 is fixed to an opening end of the magnetic yoke 74. A cylindrical part 75a is formed at a center portion of the plate 75. The auxiliary yoke 76 having a cylindrical shape (columnar shape) is fixed to a center portion of a bottom part of the magnetic yoke 74. The movable core 77 is accommodated inside the cylindrical part 75a, being reciprocally in the vertical direction (first direction d1). The electromagnetic coil 71 is provided at outer peripheral part of the movable core 77 and the auxiliary yoke 76. The magnetic yoke 74, the plate 75, the auxiliary yoke 76 and the movable core 77 constitute a magnetic circuit. The spring 73 energizes the movable core 77 in a direction along which the movable core 7 moves away from the auxiliary yoke 76.

The shaft 72 having a columnar shape is connected to the movable core 77. The shaft 72 extends in the first direction d1. The shaft 72 and the movable core 77 penetrates through the plate 75. The movable contact terminal 15 is connected (coupled) to the shaft 72 via the insulation member 85. The movable contact terminal 15 is formed in the rectangular plate shape using a conductive material. At both ends of the movable contact terminal 15 in the longitudinal direction, movable contacts 1718 are attached (provided). The movable contacts 17 and 18 are formed in a columnar shape using a conductive material. The movable contacts 17 and 18 protrude towards a fixed contact terminal 11 side at the movable contact terminal 15. Note that the movable contact terminal 15 includes the movable contacts 17, 18.

In a part positioned further up than the partitioning member 32 of the base 30, the accommodation member 21, the movable contact terminal 15, the movable contacts 17, 18, the fixed contact terminals 11, 12, fixed contacts 13, 14, the first magnet 51, the second magnet 52 and the like are provided.

The accommodation member 21 is formed in a groove shape (U-shape in a side view) using a material (e.g. resin or ceramic) having insulation and permeability properties. A pair of fixed contact terminals 11, 12 are attached to the partitioning member 32, penetrating through the rear plate member 31 of the base 30.

The fixed contact terminals 11, 12 are formed of a conductive material and arranged at predetermined intervals. A direction where the fixed contact terminals 11,12 are arranged corresponds to the longitudinal direction of the movable contact terminal 15 (direction where the movable contact terminal 15 extends from one fixed contact terminal to the other fixed contact terminal among the fixed contact terminals 11 and 12). The fixed contact terminals 11, 12 are formed in an L shape (bent rectangular shape), being along the partitioning member 32 of the base 30 and the rear plate member 31. The fixed contacts 13 and 14 are attached (provided) to end terminals in a front side of the fixed contact terminals 11 and 12, respectively. The fixed contacts 13, 14 are formed in a columnar shape with a conductive material. The fixed contacts 13, 14 protrude from the fixed contact terminals 11, 12 towards a movable contact terminal 15 side, respectively. The fixed contacts 13, 14 attached to the fixed contact terminals 11, 12 face the movable contacts 17, 18 attached to the movable contact terminal 15, respectively. Note that the fixed contact terminals 11, 12 each include the fixed contacts 13, 14.

A first magnet 51 and a second magnet 52 are mounted to an outer peripheral part of the accommodation member 21. The first magnet 51 (magnet) is disposed in a lateral side of the fixed contact 13 and the movable contact 17 with respect to the longitudinal direction of the movable contact terminal 15. The second magnet 52 (magnet) is disposed in a lateral side of the fixed contact 14 and the movable contact 18 with respect to the longitudinal direction of the movable contact terminal 15.

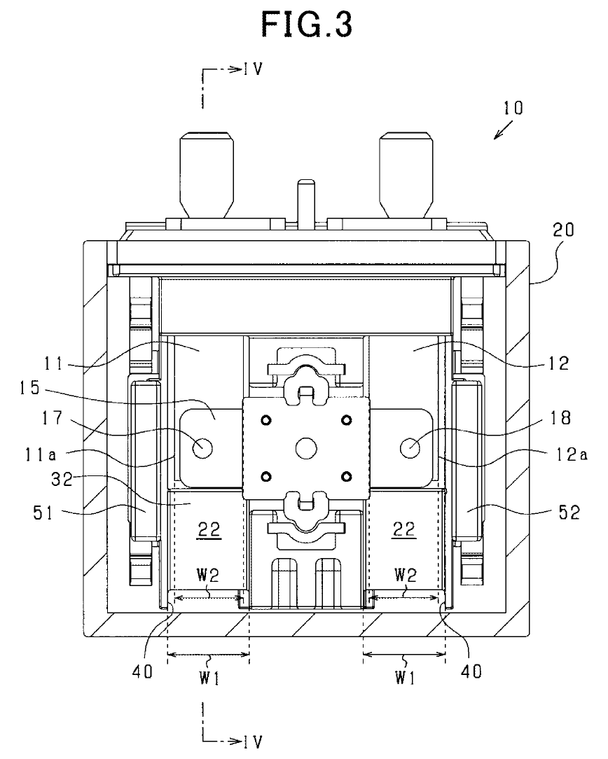

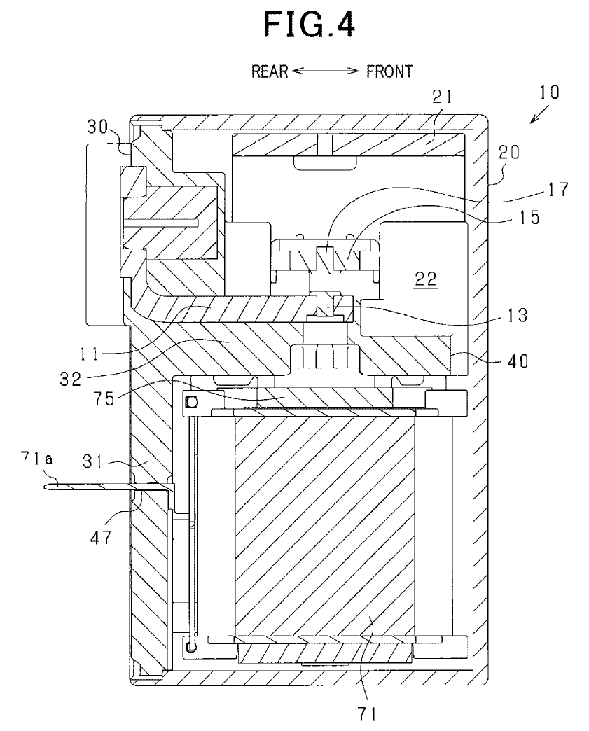

A casing 20 is mounted to the base 30. The casing 20 is formed in a bottomed rectangular prismatic shape (See FIGS. 3 and 4). An opening of the casing 20 in the rear surface side is closed (covered) by a rear plate member 31.

A lower part of the rear plate member 31 positioned lower than the portioning member 32 of the base 30, the partitioning member 32 and a lower part of the casing 20 positioned lower than the partitioning member 32 constitute a coil housing. The coil housing accommodates an electromagnetic coil 71 and an inner part of the coil housing serves as a coil chamber.

An upper part of the rear plate member 31 positioned further up than the portioning member 32 of the base 30, the partitioning member 32, the accommodation member 21 and a front part of the casing 20 positioned further up than the partitioning member 32 constitute a contact housing. The contact housing accommodates the fixed contact terminals 11, 12, the movable contact terminal 15, the fixed contacts 13, 14 and the movable contacts 17, 18 (contact part between a pair of fixed contact terminals 11, 12 and the movable contact terminal 15). An inner part of the contact housing serves as a contact chamber.

In a state where the current is not flowing through the electromagnetic coil 71, the fixed contacts 17, 18, and the movable contacts 17, 18 are apart from each other by an energizing force of the spring 73. When current flows through the electromagnetic coil 71, an electromagnetic force influences the movable core 77 to approach the auxiliary yoke 76. Thus, the movable contact terminal 15 connected to the movable core 77 via the shaft 72 and the insulation member 85 moves towards a direction along which it approaches the fixed contact terminals 11, 12 against the energizing force of the spring 73, and comes into contact with fixed contact terminals 11, 12. Specifically, the electromagnetic coil 71 produces an electromagnetic force which causes the movable contacts 17, 18 (movable contact terminal 15) to approach a pair of fixed contacts 13, 14 (a pair of fixed contact terminals 11, 12). Thus, the movable contact terminal 15 causes the fixed contact terminal 11 and the fixed contact terminal 12 to be conducted. That is, the movable contact terminal 15 approaches the pair of fixed contact terminals 11, 12 and separates from the pair of fixed contact terminals 11, 12, thereby making a portion between the pair of fixed contact terminals 11, 12 conducted or cutoff. Specifically, the movable contacts 17, 18 each approaches the pair of fixed contacts 13, 14 and separates from the pair of fixed contacts 13, 14.

In the case where the fixed contacts 13, 14 and the movable contacts 17, 18 changes the state from a state of being contacted with each other to a state of being away from each other, arc possibly occurs between the fixed contacts 13, 14 and the movable contacts 17, 18. In this respect, an arc extinguishing chamber 22 is formed inside the contact terminal housing, as a space where the arc is extended to be cutoff (see FIGS. 3 and 4). The arc extinguishing chamber 22 is formed in a lateral side of the fixed contacts 13, 14 and the movable contacts 17, 18 (in a direction perpendicular to paper surface of FIG. 1) with respect to a short-side direction of the movable contact terminal 15 (longitudinal direction of the fixed contact terminals 11, 12). The first magnet 51 produces a magnetic field causing an arc produced between the fixed contact 13 and the movable contact 17 to be extended in a direction towards the arc extinguishing chamber 22 (guiding an arc to the arc extinguishing chamber 22). The second magnet 52 produces a magnetic field causing an arc produced between the fixed contact 14 and the movable contact 18 to be extended in a direction towards the arc extinguishing chamber 22 (guiding an arc to the arc extinguishing chamber 22).

Hence, the arc produced between the fixed contacts 13, 14 and the movable contacts 17, 18 is extended towards a front side (in a direction opposite to the rear plate member 31; predetermined direction) with a magnetic field of the magnets 51 and 52, and the arc is guided to the arc extinguishing chamber 22, thereby cooling the arc to be cutoff. However, in a case of a hybrid vehicle or an electric vehicle in which a large amount of current flows through the electromagnetic relay 10, an arc occurring at the electromagnetic relay 10 is difficult to cut off.

For this reason, as shown in FIG. 4, in the portioning member 32 of the contact terminal housing, a communication hole 40 is formed at a portion closer to a front side (portion in a direction opposite to the rear plate member 31; predetermined direction) than the position of the fixed contact 13 (14) and the movable contact 17 (18) is, in order to communicate between a upper part positioned further up than the partitioning member 32 (a part close to the fixed contact terminals 11, 12 and the movable contact terminal 15 side) and a lower part (electromagnetic coil 71 side). The communication hole 40 communicates between the arc extinguishing chamber 22 (contact chamber) and a coil chamber (inside the coil housing, outside of the arc extinguishing chamber 22). The communication hole 40 is formed at an end portion of the partitioning member 32 (contact terminal housing) in a front side. In other words, the communication hole 40 is a gap having a predetermined width formed between the front end of the portioning member 32 and the casing 20. As shown in FIG. 3, a width w1 of the communication hole 40 is wider than a width w2 of an end portion of the fixed contact terminals 11a, 12a in a front part, with respect to a direction where the movable contact terminal 15 extends from one of the pair of fixed contact terminals 11, 12 to the other one of the pair of fixed contact terminals 11, 12 (longitudinal direction of the movable contact terminal 15). Specifically, in the longitudinal direction of the movable contact 15, the width w1 of the communication hole 40 is wider than the width w2 of the fixed contact terminals 11, 12 over the entire part of the fixed contacts 11, 12.

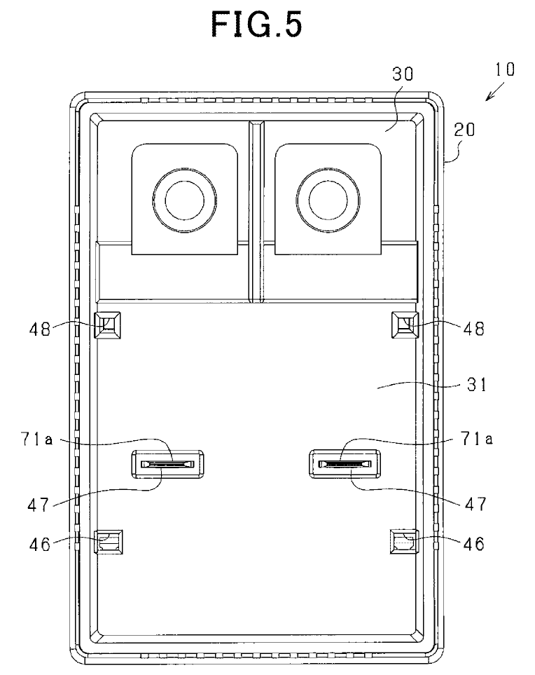

As shown in FIGS. 4 and 5, in an intermediate part (coil housing) of the rear plate member 31 of the base 30 in the vertical direction, an air-vent hole 47 is formed for communicating between the coil chamber (inside the coil housing) and outside the coil chamber (outside air). Specifically, a pair of terminal parts 71a of the electromagnetic coil 71 protrudes towards a rear side, penetrating through the rear plate member 31. The air-vent hole 47 is formed at a portion immediately below (a lower part) the respective terminal parts 71a of the electromagnetic coil 71 in the rear plate member 31. In other words, the arc extinguishing chamber 22 is configured to communicate with outside air via the coil chamber. The air-vent hole 47 is formed at each of portions near the left and right ends of the rear plate member 31. The air-vent hole 47 is formed at a portion a predetermined distance away from the partitioning member 32 in the vertical direction (axial direction of the electromagnetic coil 71 and the shaft 72). In the coil housing, an end portion in a front part (a predetermined direction side) communicates with the arc extinguishing chamber 22 via the communication hole 40, and an end portion in a rear part (opposite side of the predetermined direction side) communicates with outside air via the air-vent hole 47. Note that through- holes 46, 48 are provided for allowing adhesive agent to flow therethrough for fixing components when assembling the electromagnetic relay 10.

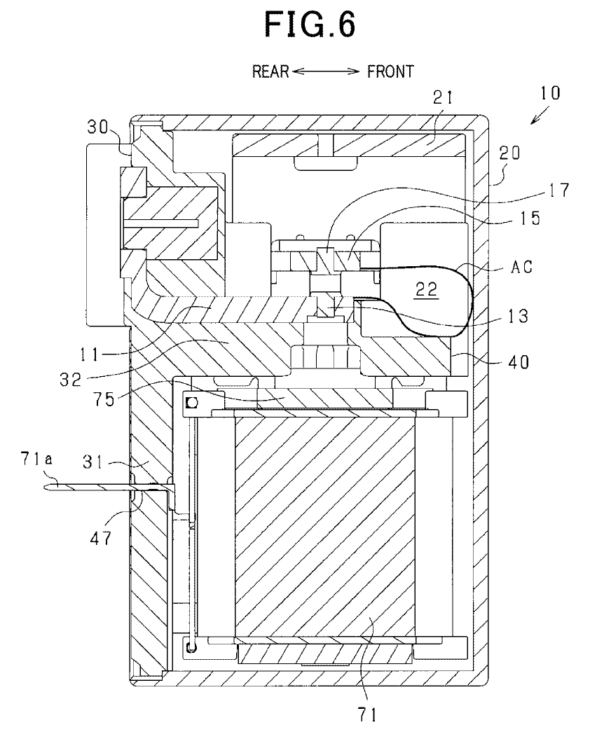

According to the electromagnetic relay 10 having the above-described configurations, for example, it is assumed that an arc occurs between the fixed contact 13 and the movable contact 17, as shown in FIG. 6, due to a magnetic field of the first magnet 51, an arc ac is extended towards a front side of the casing 20 (right direction in FIG. 6) and guided to the arc extinguishing chamber 22. The arc ac is further extended towards a front side in the arc extinguishing chamber 22 and reaches the casing 20. At this moment, an end portion of the arc ac in a front side is positioned in an upper side of communication hole 40. That is, the arc ac is extended in a direction to approach the communication hole 40 from a portion between the fixed contact 13 and the movable contact 17.

Here, the arc ac generates a large quantity of heat and a temperature of the air and a pressure inside the arc extinguishing chamber 22 increase. The heat generated by the arc ac is discharged to the coil chamber (inside the coil housing) through the communication hole 40, and the increased pressure due to the arc ac is lowered (released). Thus, arc ac in the arc extinguishing chamber 22 is effectively cooled.

Further, an origin of the arc ac may move in the longitudinal direction of the movable contact terminal 15 within a width w2 of the end portion 11a in a front side (predetermined direction) of the fixed contact terminal 11. In this respect, as shown in FIG. 3, the width w1 of the communication hole 40 is wider than the width w2 of the end portion in the font side of the fixed contact terminal 11 in the longitudinal direction of the movable contact terminal 15. Hence, even in the case where the origin of the arc ac moves in the longitudinal direction of the movable contact 15 from a time when the arc ac is produced to a time when the arc ac is cut off, the arc ac extended in a front side can be prevented from being positioned outside the width w1 of the communication hole 40.

When the arc ac and the pressure are released to the coil chamber from the arc extinguishing chamber 22, the temperature and the pressure in the coil chamber increase. Then, the heat and the pressure are released outside (outside the coil chamber) through the air-vent hole 47 formed at the rear plate member 31 of the base 30. Then, in the coil housing, the communication hole 40 is disposed at the end portion in a front side and the air-vent hole 47 is disposed at the end portion in the rear side. Hence, the heat and the pressure released outside the coil chamber from the communication hole 40 passe through the coil chamber from the front side to the rear side of the coil chamber. Thereafter, the heat and the pressure are released outside (to atmospheric air) from the air-vent hole 47.

The present embodiment as described above in detail has the following effects and advantages.

In the contact terminal housing (upper part of the rear plate member 31, the partitioning member 32, the accommodation member 21 and an upper part of the front surface part of the casing 20), the communication hole 40 is formed in a front side (in predetermined direction) of the fixed contacts 13, 14 and the movable contacts 17, 18 (contact part) so as to cause the arc extinguishing chamber 22 to communicate with outside the arc extinguishing chamber 22. Hence, the arc ac can be extended towards a direction along which the arc approaches the communication hole 40. Then, the heat generated by the arc ac and the pressure increased by the arc ac can be released outside the arc extinguishing chamber 22 from the communication hole 40. Hence, arc ac can be effectively cooled, thereby improving a performance for cutting off arc ac.

The communication hole 40 is formed at an end portion in the front part of the partitioning member 32 in the contact terminal housing. According to such a configuration, in a state where the arc ac is extended towards front side to reach the end portion of the contact terminal housing, the arc ac can be at the closest position to the communication hole 40. Hence, arc ac can be cutoff easily in the case where the arc ac is extended to the end portion in a front side of the contact terminal housing without cutting off the arc ac.

The width w1 of the communication hole 40 is wider than the width w2 of the front end parts 11a, 12a of the fixed contact terminals 11, 12 with respect to the longitudinal direction (left-right direction) of the movable contact terminal 15. According to such a configuration, even when the origin of arc ac moves within the width w2 of the front end parts 11a, 12a of the fixed contact terminals 11, 12, the origin of the arc ac can be prevented from being positioned outside the width w1 of the communication hole 40. Therefore, the arc ac extended towards front side can be prevented from being positioned outside the width w1 of the communication hole 40, whereby arc ac can be effectively cooled.

The arc extinguishing chamber 22 and an inside portion of the coil housing (a lower part of the rear plate member 31, the partitioning member 32 and a lower part of the casing 20) are communicated by the communication hole 40. Hence, the heat and the pressure caused by the arc ac can be released inside the coil housing from the arc extinguishing chamber 22 through the communication hole 40. Accordingly, an inside portion of the coil housing can be utilized as a space for releasing heat and pressure in the arc extinguishing chamber 22.

In the coil housing, an air-vent hole 47 is formed for communicating between an inside portion of the coil housing and outside air. According to such a configuration, the heat and the pressure released inside the coil housing can be released to outside air through the communication hole 47. Hence, an inside portion of the coil housing, that is, an inside portion of the arc extinguishing chamber 22 can be effectively cooled and a performance of cutting off the arc ac can be improved. Further, since the arc extinguishing chamber 22 is communicated with outside air through the inside portion of the coil housing, the heat and the pressure in the arc extinguishing chamber 22 can be prevented from being vigorously discharged outside.

In the coil housing, an end portion in the front side is communicated with the arc extinguishing chamber 22 through the communication hole 40, and an end portion in the rear side (opposite side of a predetermined direction) is communicated with outside air through the air-vent hole 47. According to such a configuration, since the communication hole 40 and the air-vent hole 47 are provided at both ends of the coil housing in the front-rear direction, respectively, the heat and the pressure released inside the coil housing can be prevented from being rapidly discharged from the communication hole 40 to the air-vent hole 47. Hence, the heat and the pressure in the arc extinguishing chamber 22 can be effectively prevented from being vigorously discharged outside.

The above-described embodiments can be modified in the following manners. For configurations same as those in the above-described embodiments, the same reference symbols are applied and the explanation thereof will be omitted.

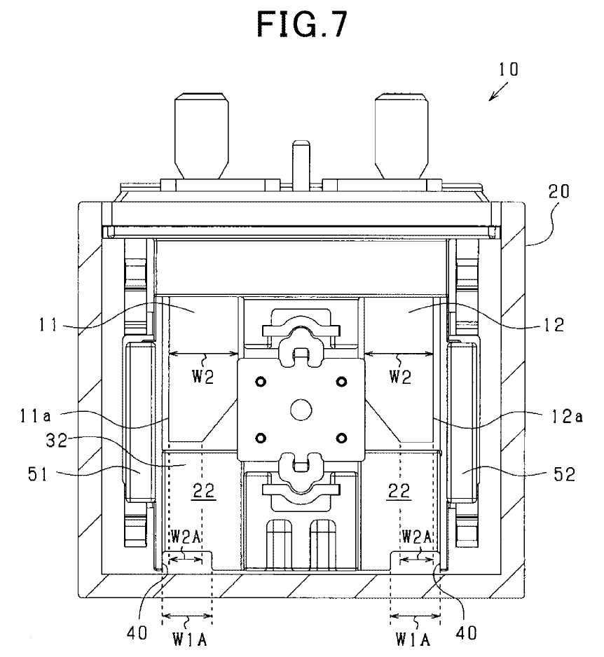

As shown in FIG. 7 in which the movable contact terminal 15 and the movable contacts 17, 18 are roughly illustrated, the width w2a of the front end parts 11a, 12a of the fixed contact terminals 11, 12 may be narrower than the width w2 of the other part of the fixed contacts 11, 12. Thus, in the longitudinal direction (left-right direction) of the movable contact terminal 15, the width w1a of the communication hole 40 may be wider than the width w2a of the front end parts 11a, 12a of the fixed contact terminals 11, 12. According to such a configuration, even when the origin of the arc moves within a range of the width w2a of the front end parts 11a, 12a of the fixed contacts 11, 12, the origin of the arc can be prevented from being positioned outside the width w1a of the communication hole 40. Hence, the arc extended in the front side can be prevented from being positioned outside the width w1a of the communication hole 40, thereby effectively cooling the arc.

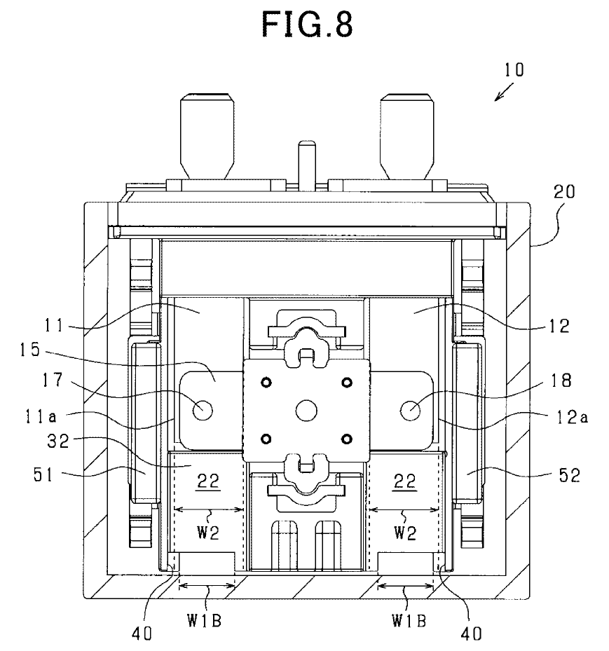

In the longitudinal direction (left-right direction) of the movable contact terminal 15, the width w1 of the communication hole 40 can be the same as the width w2 of the front end parts 11a, 12a of the fixed contact terminals 11,12. Also, as shown in FIG. 8, in the longitudinal direction (left-right direction) of the movable contact terminal 15, the width w1b of the communication hole 40 can be narrower than the width w2 of the front end parts 11a, 12a of the fixed terminals 11, 12.

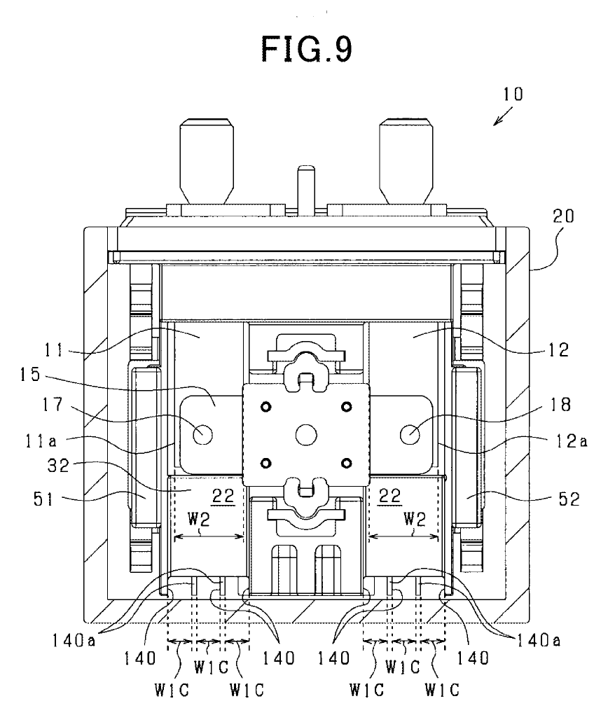

As shown in FIG. 9, in a range of the width w2 of the front end part 11a (12a) of the fixed contact 11 (12), a plurality of communication holes 140 may be formed. In this case, in the longitudinal direction (left-right direction) of the movable contact terminal 15, the width w1c of the communication hole 140 is narrower than the width w2 of the front end part 11a (12a) of the fixed terminal 11 (12). According to such a configuration, causing an arc to contact the partitioning member 140a that partitions the plurality of communication holes 140, an arc can readily be cutoff.

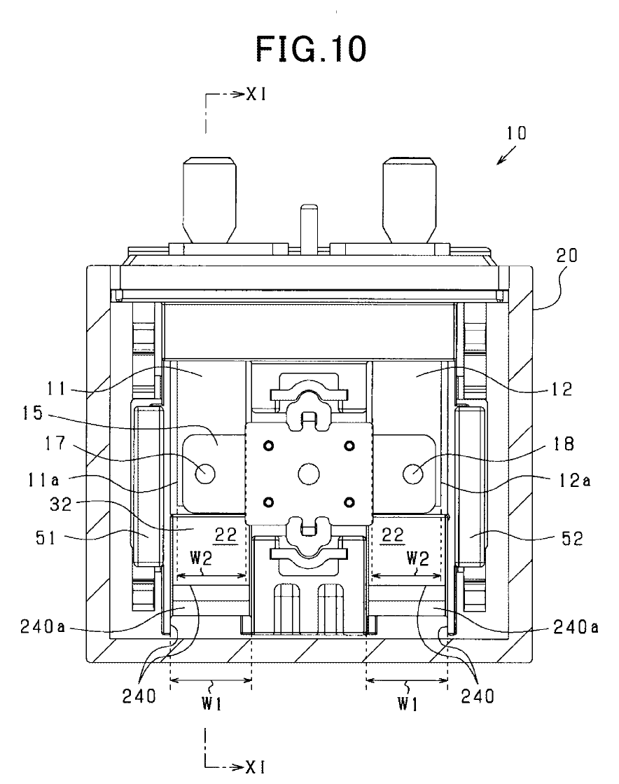

As shown in FIGS. 10,11, in the front-rear direction (longitudinal direction of the fixed contact terminals 11, 12), a plurality of communication holes 240 may be formed at the partitioning member 32 of the base 30. According to such a configuration, heat generated by the arc and pressure increased by the arc can be released outside the arc extinguishing chamber 22 from the plurality of communication holes 240. Hence, the arc can be effectively cooled and the performance of cutting off the arc can be improved. Further, causing an arc to contact with the partitioning member 240a that partitions the plurality of communication holes 240, the arc can readily be cutoff.

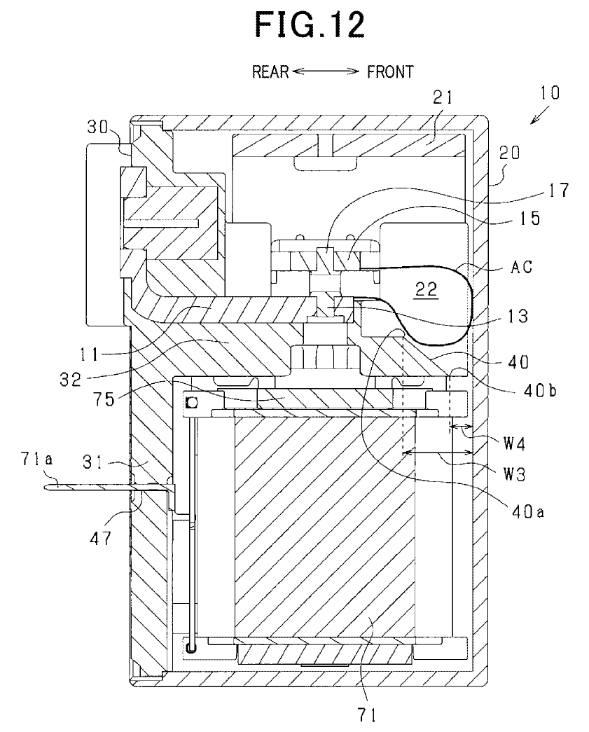

As shown in FIG. 12, an opening 40a of the communication hole 40 in an arc extinguishing chamber 22 side may be set to be larger than an opening 40b of the communication hole 40 in a coil chamber side (opposite side of the arc extinguishing chamber 22). Specifically, in a front-rear direction (longitudinal direction of the fixed contact terminals 11, 12) of the electromagnetic relay 10, the width w3 of the opening 40a in the arc extinguishing chamber 22 side is wider than the width w4 of the opening 40b in the coil chamber side. Since an inner surface of the communication hole 40 is inclined from the opening 40a to the opening 40b, the width thereof is reduced. Also, in this case, the openings 40a and 40b are formed at a front end part of the partitioning member 32. According to such a configuration, arc, heat generated by the arc, pressure increased by the arc can readily be lead inside the communication hole 40 from the arc extinguishing chamber via the opening 40a. Hence, arc can be effectively cooled and the performance of cutting off the arc can be improved.

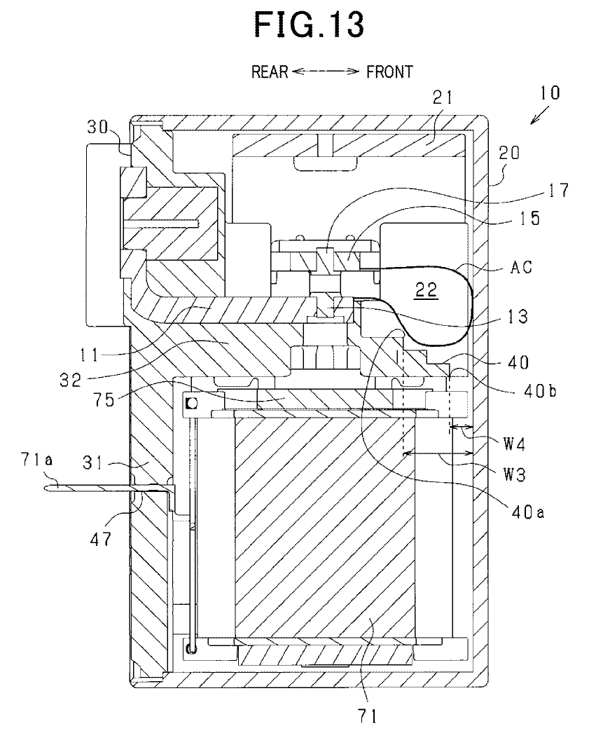

As shown in FIG. 13, an inner surface of the communication hole 40 may be formed stepwise from the opening 40a to the opening 40b of the communication hole 40, whereby the width thereof is reduced. Also in this case, the openings 40a and 40b are formed at a front end part of the partitioning member 32. With such a configuration, arc, heat generated by the arc, pressure increased by the arc can readily be lead inside the communication hole 40 from the arc extinguishing chamber 22 via the opening 40a.

Note that the openings 40a, 40b may be formed in a portion positioned closer to the fixed contact 13 and the movable contact 17 (contact part) than to a position of the front end part of the partitioning member 32. Moreover, the opening 40a in an arc extinguishing chamber 22 side of the communication hole 40 may be the same in size of the opening 40b in a coil chamber side of the communication hole 40 or may be smaller in size than the opening 40b.

One air-vent hole 47 may be formed at each of intermediate parts of the rear plate member 31 in the left-right direction.

In the coil housing, the front end part may be communicated with the arc extinguishing chamber 22 through the communication holes 40, 140, 240 and the intermediate part in the front-rear direction may be communicated with outside air (outside the coil chamber).

One of two air-vent holes 47 may be omitted. Also, both of the two air-vent holes 47 may be omitted. Even in this case, heat and pressure due to arc can be released to the coil chamber (outside the arc extinguishing chamber 22) from the communication holes 40, 140, 240, whereby the arc can be effectively cooled. Therefore, compared to a case where the communication holes 40, 140 and 240 are not formed at the contact terminal housing, the performance of cutting off the arc can be improved.

In the contact terminal housing that accommodates the fixed contact terminals 11, 12 and the movable contact terminal 15, an air-vent hole (communication hole) that communicates between the arc extinguishing chamber 22 (contact chamber) and outside air (outside the arc extinguishing chamber 22). For example, an air-vent hole can be formed at a front surface part (a part positioned in a front side of the fixed terminals 13, 14, and the movable contacts 17, 19) of the casing 20 (contact terminal housing). Also with such a configuration, since the heat generated by the arc and the pressure increased by the arc can be released outside the arc extinguishing chamber 22 from the air-vent hole, the arc can be effectively cooled.

The fixed contact terminal 11 and the fixed contact 13 may be formed of a single member (i.e. integrated). The fixed contact terminal 12 and the fixed contact 14 may be formed of a single member (i.e. integrated). The movable contact terminal 15 and the movable contacts 17, 18 may be formed of a single member (i.e. integrated).

Magnets may be each provided at corresponding one of the fixed contact terminals 11, 12 in the longitudinal direction (front-rear direction), and an arc extinguishing chamber may be provided for each of a left side portion and a right side portion of the movable contact terminal 15 in the longitudinal direction (left-right direction). In this case, a communication hole that communicates between the arc extinguishing chamber and outside the arc extinguishing chamber s may be each provided at a portion positioned in a left side (in a predetermined direction) and a portion positioned in a right side (in a predetermined direction) relative to a contact part between the pair of fixed contact terminals and the movable contact.

The above-described embodiments and modification examples may be appropriately combined and embodied.

The present disclosure has been described in accordance with the embodiments. However, the present disclosure is not limited to the embodiments and structure thereof. The present disclosure includes various modification examples and modifications within the equivalent configurations. Further, various combinations and modes and other combinations and modes including one element or more or less elements of those various combinations are within the range and technical scope of the present disclosure.

### Conclusion

The present disclosure provides an electromagnetic relay capable of improving the performance of cutting off the arc.

A first means to solve the above-described issues is an electromagnetic relay provided with a pair of fixed contact terminals arranged at predetermined intervals; a movable contact terminal that approaches the pair of fixed contact terminals and separates from the pair of fixed contact terminals, thereby making a portion between the pair of fixed contact terminals conducted or cutoff; a contact part between the pair of fixed contact terminals and the movable contact; a contact terminal housing that accommodates the pair of fixed contact terminals, the movable contact terminal and the contact part, the contact terminal housing including an arc extinguishing chamber arc extinguishing chamber formed therein as a space used for extending an arc produced between the fixed contact terminals and the movable contact terminal; and a magnet that produces a magnetic field causing the arc to be extended in a predetermined direction and guiding the arc to the arc extinguishing chamber , wherein a communication hole is provided in the contact terminal housing, formed at a portion positioned in a predetermined direction relative to the contact part, the communication hole causing the arc extinguishing chamber to communicate with outside of the arc extinguishing chamber .

According to the above-described configuration, a pair of fixed contact terminals are arranged at predetermined intervals. The movable contact terminal approaches the pair of fixed contact terminals and separates from the pair of fixed contact terminals, thereby making a portion between the pair of fixed contact terminals conducted or cutoff. Hence, when a state changes from a state where the movable contact terminal approaches the pair of fixed contact terminals to cause the portion between the pair of fixed contacts conducted, to a state where the movable contact terminal is separated away from the pair of fixed contact terminals to cause the portion between the pair of fixed contact terminals to be cut off, an arc possibly occurs between a portion between the fixed contact terminal and the movable contact.

In this respect, the contact terminal housing accommodates the contact part between the pair of fixed contact terminals and the movable contact, including the arc extinguishing chamber formed therein as a space used for extending an arc produced between the fixed contact terminals and the movable contact terminal. Then, the magnet produces a magnetic field causing the arc to be extended in a predetermined direction and guiding the arc to the arc extinguishing chamber. Hence, the arc produced between the fixed contacts and the movable contacts is extended in a predetermined direction using magnetic field of the magnet, and the arc is guided to the arc extinguishing chamber, thereby cooling the arc to be cutoff. However, in the case where a large amount of current flows through the electromagnetic relay, an arc occurring at the electromagnetic relay is difficult to cut off.

For this reason, a communication hole is provided in the contact terminal housing, formed at a portion positioned in a predetermined direction relative to the contact part, the communication hole causing the arc extinguishing chamber to communicate with outside the arc extinguishing chamber. Then, heat generated by the arc and pressure increased by the arc can be released outside the arc extinguishing chamber from the communication hole. Hence, the arc can be effectively cooled and the performance of cutting off the arc can be improved.

As a second means, the communication hole is formed at an end portion of the contact terminal housing in the predetermined direction. According to such a configuration, in a state where the arc is extended in the predetermined direction to an end portion of the contact terminal housing, the arc can be at the closest position to the communication hole. Accordingly, in the case where arc is extended to an end portion of the contact terminal housing in the predetermined direction without cutting off the arc, the arc can readily be cut off.

In a direction where the movable contact terminal extends from one fixed contact terminal to the other fixed contact terminal among the pair of fixed contact terminals, the origin of arc may be moved within a width range of the end portion of the fixed contact terminal in the predetermined direction.

In this respect, as a third means, in a direction where the movable contact terminal extends from one fixed contact terminal to the other fixed contact terminal among the pair of fixed contact terminals, a width of the communication hole is wider than a width of the end portion of the fixed contact terminal in the predetermined direction. According to such a configuration, even when the origin of an arc is moved within a width range of the end portion of the fixed contact terminal in the predetermined direction, the origin of the arc can be prevented from moving outside the width range of the communication hole. Hence, the arc extended in the predetermined direction can be prevented from moving outside the width of the communication hole, thereby effectively cooling the arc.

As a fourth means, an opening of the communication hole in an arc extinguishing chamber side is larger than an opening of the communication hole in an opposite side of the arc extinguishing chamber. According to such a configuration, an arc, heat generated by the arc, pressure increased by the arc can readily be lead inside the communication hole via the opening. Hence, the arc can be effectively cooled and the performance of cutting off the arc can be improved.

As a fifth means, the electromagnetic relay is provided with an electromagnetic coil that generates electromagnetic force causing the movable contact terminal approach the pair of fixed terminals and a coil housing that accommodates the electromagnetic coil and the communication hole communicates between the arc extinguishing chamber and an inner part of the coil housing.

According to the above-described configuration, the communication hole communicates between the arc extinguishing chamber and an inner part of the coil housing. Hence, heat and pressure caused by the arc can be released inside the coil housing from the arc extinguishing chamber through the communication hole. Therefore, an inside portion of the coil housing can be utilized as a space for releasing heat and pressure in the arc extinguishing chamber.

As a sixth means, an air-vent hole is formed in the coil housing to communicate between an inside part of the coil housing and outside air. According to such a configuration, the heat and the pressure released inside the coil housing can be released to outside air through the communication hole. Hence, an inside portion of the coil housing, that is, an inside portion of the arc extinguishing chamber, can be effectively cooled and a performance of cutting off the arc can be improved. Further, since the arc extinguishing chamber is communicated with the outside air through the inside portion of the coil housing, the heat and the pressure in the arc extinguishing chamber can be prevented from being vigorously discharged outside.

As a seventh means, an end portion of the coil housing in the predetermined direction is communicated with the arc extinguishing chamber by the communication hole, and an end portion of the coil housing in an opposite side of the predetermined direction communicates with outside air. According to such a configuration, since the communication hole and the air-vent hole are provided at both ends of the coil housing respectively, the heat and the pressure released inside the coil housing can be prevented from being rapidly discharged from the communication hole to the air-vent hole. Hence, the heat and the pressure in the arc extinguishing chamber can be effectively prevented from being vigorously discharged outside.

What is claimed is:

1. An electromagnetic relay comprising:
a pair of fixed contact terminals arranged at predetermined intervals;
a movable contact terminal that approaches the pair of fixed contact terminals and separates from the pair of fixed contact terminals, thereby making a portion between the pair of fixed contact terminals conducted or cutoff;
a contact part between the pair of fixed contact terminals and the movable contact;
a contact terminal housing that accommodates the pair of fixed contact terminals, the movable contact terminal and the contact part, the contact terminal housing including an arc extinguishing chamber formed therein as a space used for extending an arc produced between the fixed contact terminals and the movable contact terminal; and
a magnet disposed in a lateral side of the contact part with respect to a direction where the movable contact terminal extends from one fixed contact terminal to the other fixed contact terminal among the pair of fixed contact terminals, the magnet producing magnetic field causing the arc to be extended in a predetermined direction and guiding the arc to the arc extinguishing chamber, wherein
a communication hole is provided in the contact terminal housing, formed at a portion positioned in a predetermined direction relative to the contact part, the communication hole causing the arc extinguishing chamber to communicate with outside the arc extinguishing chamber.

2. The electromagnetic relay according to claim 1, wherein
the communication hole is formed at an end portion of the contact terminal housing in the predetermined direction.

3. The electromagnetic relay according to claim 1, wherein
in a direction where the movable contact terminal extends from one fixed contact terminal to the other fixed contact terminal among the pair of fixed contact terminals, a width of the communication hole is wider than a width of the end portion of the fixed contact terminal in the predetermined direction.

4. The electromagnetic relay according to claim 1, wherein
an opening of the communication hole in an arc extinguishing chamber side is larger than an opening of the communication hole in an opposite side of the arc extinguishing chamber.

5. The electromagnetic relay according to claim 1, wherein
the electromagnetic relay is provided with an electromagnetic coil that generates electromagnetic force causing the movable contact terminal to approach the pair of fixed terminals and a coil housing that accommodates the electromagnetic coil; and
the communication hole communicates between the arc extinguishing chamber and an inner part of the coil housing.

6. The electromagnetic relay according to claim 5, wherein
an air-vent hole is formed in the coil housing to communicate between an inside part of the coil housing and outside air.

7. The electromagnetic relay according to claim 6, wherein
an end portion of the coil housing in the predetermined direction is communicated with the arc extinguishing chamber by the communication hole, and an end portion of the coil housing in an opposite side of the predetermined direction communicates with outside air.
